(19) United States
(12) Patent Application Publication
(10) Pub. No.: US 2008/0179846 A1
(43) Pub. Date: Jul. 31, 2008

(54) Golf bag and golf bag pull cart transportation and storage device powered by a rechargeable 12 volt D/C Battery for use with motor vehicles

(76) Inventors: Joel Felix Dube, (US); David Lionel Dube, (US)

Correspondence Address: DAVID LIONEL DUBE';JOEL FELIX DUBE', 4 BEACON HILL ROAD, WINDHAM, NH, 03087, US

(21) Appl. No.: 11/668,452

(22) Filed: Jan. 29, 2007

(51) Int. Cl. B62B 1/00

(52) U.S. Cl. 280/47.26

(57) ABSTRACT

A golf bag and golf bag pull cart transportation and storage device powered by a rechargeable 12 volt D/C battery for use with motor vehicles. What is described is a tongue affixed to the rear of a motor vehicle utilizing the motor vehicle hitch receiver. Attached to the tongue is a platform. The platform having swivel caster wheels affixed to the dorsum of the platform. The platform having support means to stabilize the golf equipment during transport. A gear motor, powered by a 12 volt D/C battery pack. The platform is movable vertically via the gear motor into an elevated position for attachment to the motor vehicle hitch receiver. The platform can be either elevated and/or lowered to perform two functions. First, for the tongue of the invention to be elevated to such a height where it can be positioned at the height of the motor vehicle hitch receiver for ease of insertion, the invention need not be lifted for placement into the motor vehicle hitch receiver. Second, once positioned in the motor vehicle hitch receiver, the platform containing golf bags and golf bag pull carts is elevated via the gear motor.

### FIELD OF THE INVENTION

The following invention relates to support structures attached to the rear of motor vehicles, for the purpose of transporting and storing golf equipment. More specifically golf bags with and/or without their respective golf bag pull carts.

### BACKGROUND OF THE INVENTION

It is well known that to play the game of golf, golf equipment is needed. The majority of golf courses state that each player must supply their own golf equipment to play golf as listed in the rules of play. Specifically golf clubs as well as a golf bag to support/carry and organize the above mentioned golf clubs. In addition, golfers can opt to utilize a golf bag pull cart, which supports the golf equipment and allows the golf equipment to be rolled while navigating one's way around the golf course. Golf bag pull carts are widely used by golfers wishing to walk the golf course and not be physically burdened by carrying their golf equipment. As in many cases, the weight of their golf equipment is in excess of what the golfer can safely carry and unnecessary strain and fatigue could result.

Due to the necessity for golfers to require considerable equipment as mentioned above to partake in the activity of golfing, as well as the need for golfers to travel to and from the golf course in their motor vehicles, a need is seen to ease the process of transporting golfers as well as cumbersome, heavy and space occupying golf equipment via motor vehicles to and from the golf course.

In prior art vehicle mounted golf equipment transportation patents to Stark (U.S. Pat. No 6,039,227), Ewing (U.S. Pat. No. 6,554,171), Mullen (U.S. Pat. No. 6,494,352), D'Angelo (U.S. Pat. No. 5,806,738), and Neale (U.S. Pat. No. 6,786,693), all are addressing the golfer's dilemma of safely and efficiently transporting their golf equipment to and from the golf course. However, the above, mentioned prior art fails to address several very important aspects. Since the prior art where they are addressing the transportation of golf equipment fails to supply the invention with caster wheels along the dorsum of the invention, they all require the user to carry and lift the said invention to the location of the motor vehicle to which it will be utilized. The prior art also fails to supply a means in which to eliminate the user from manually lifting the said invention for attachment to the rear mount position of a motor vehicle hitch receiver. Motor vehicles vary in size and shape; in some cases the motor vehicle hitch receiver may be several feet above ground height. As a result, the user is forced to lift the said prior art patent in an upward direction for attachment to the motor vehicle hitch receiver. The prior art also fails to supply a way in which the user is void of manually lifting their heavy and awkward golf equipment, including the golf bag pull cart, up and onto the said prior art golf equipment motor vehicle mounted racks. As mentioned prior, the relative height of the motor vehicle golf rack may in many instances be several feet above ground height.

Specification as required by 35 USC 112:

### SUMMARY OF THE INVENTION

The present application claims priority to U.S. Provisional Application No. 60/763486, filed Jan. 30, 2006 and hereby incorporated by reference herein.

A golf-bag and golf-bag pull-cart transportation and storage device powered by a rechargeable 12 volt battery, for use with motor vehicles.

This invention is a self-contained, 12V D/C-powered golf-bag and pull-cart lifting, transportation and storage system, which can be affixed to a motor vehicle via the vehicles trailer hitch receiver.

The bottom of the inventions platform has three wheels affixed, in order to enable the system, when loaded with two golf bags and pull carts to be wheeled from one location to another. The invention eliminates all lifting when transporting fully loaded golf bags including pull carts via a motor vehicle.

The invention includes an adapter sleeve, which can be secured to a motor vehicle's hitch receiver. The adapter sleeve is sized in such a way, that a tab on the tongue of the outer tube will align the tongue and adapter sleeve holes to enable insertion of retaining pin.

A tower consisting of two telescoping hollow square tubes, is secured directly to the adapter sleeve within the hitch receiver, or alternatively directly to the hitch receiver via a tongue affixed to the outer tube. The tongue has a single swivel caster wheel attached on the underside. The inner tube is extended and retracted via a screw drive. The screw drive consists of a gear motor powered by an on-board rechargeable 12 V D/C battery and threaded shaft affixed to the gear motor, both the gear motor and the threaded shaft are affixed to the outer tube. The threaded shaft then passes through a nut affixed to the top of the inner tube. The gear motor spins the threaded shaft in order to extend or retract, the inner tube, in a vertical direction, based upon direction of spin.

Affixed to the bottom of the inner tube is a platform, which accommodates two fully loaded golf-bags, with or without golf-bag pull-carts attached to the golf-bag. There are two; removable supports attached to the platform, which cradle the golf-bags and golf-bag pull-carts. The supports have straps affixed to them in order to prevent the golf-bags and golf-bag pull-carts from becoming dislodged.

Affixed to the bottom of the platform are two swivel caster wheels, one on either side.

When the inner tube is fully retracted, the invention can be rolled from one location to another, on the three swivel caster wheels. The golf-bags and golf-bag pull-carts can remain affixed to the invention as a means of storage.

The invention permits the user to roll the golf-bag and golf-bag pull-cart up to and pivot the bag and cart directly onto the platform, thus eliminating the need to lift the golf-bag and golf-bag pull-cart into place. The golf-bag and golf-bag pull-cart can be removed from the platform in the same manner.

Once the golf-bag and golf-bag pull-cart are placed onto the platform and strapped into place the platform is then raised into it's elevated position for transport via motor vehicle.

### BRIEF DESCRIPTION OF THE DRAWINGS

FIG. 1 is a perspective view of the golf bag and golf bag pull cart transportation and storage device powered by a rechargeable 12 volt D/C battery, for use with motor vehicles. The invention is viewed from the front, left lateral and from slight elevation.

FIG. 2 is a perspective view of a platform of the invention. The view is of the platform and tower outer surfaces from a caudal view illustrating three swivel caster wheels. Two swivel caster wheels along the platforms caudal surface, as well as one swivel caster wheel along the tower outer tubes caudal surface.

FIG. 3 is a perspective lateral view of an adapter sleeve and tower outer tube of the invention.

FIG. 4 is a perspective aligned view of the invention, illustrating the tower outer tube tab on the tower outer tube.

FIG. 5 is a perspective view of the golf bag and golf bag pull cart transportation and storage device powered by a rechargeable 12 volt D/C battery, for use with motor vehicles. The invention is viewed from the front, left lateral and from slight elevation. The illustration is demonstrating an extended position of the invention.

FIG. 6 is a perspective view of a 12 volt D/C battery of the invention. This illustration is demonstrating the attached and detached positions of the 12 volt D/C battery.

### SUMMARY OF THE INVENTION

The present invention is a golf bag and golf bag pull cart transportation and storage device powered by a rechargeable 12 volt D/C battery for use with motor vehicles.

The invention utilizes the standard sizes of motor vehicle hitch receivers to support the invention as it is secured to the rear of the motor vehicle. Standard size motor vehicle hitch receivers are typically 2 inch as well as 1¼ inch sizes. Readily available motor vehicle hitch adapters allow the invention to be used with either of the above mentioned sizes. The invention's tongue, once secured to the motor vehicle hitch receiver, need not be removed for the invention to be utilized. The tongue and hitch receiver can be locked, with standard readily available locks to retain the tongue within the motor vehicle hitch receiver.

The invention, having swivel caster wheels along the dorsum of the platform, has the ability to be rolled by the user to the location of the motor vehicle, eliminating the need to be lifted in any fashion. The user can then position their golf equipment onto the invention, at ground height again utilizing the swivel caster wheels to roll the invention loaded with golf equipment to the position of the motor vehicle.

The invention having a self-powered lifting mechanism, once positioned to the rear of the motor vehicle, attaches to the tongue as mentioned above. The user then utilizes the self-powered lifting mechanism to elevate the invention loaded with all the necessary golf equipment, eliminating any and all manual lifting for the user.

### DETAILED DESCRIPTION OF THE DRAWINGS

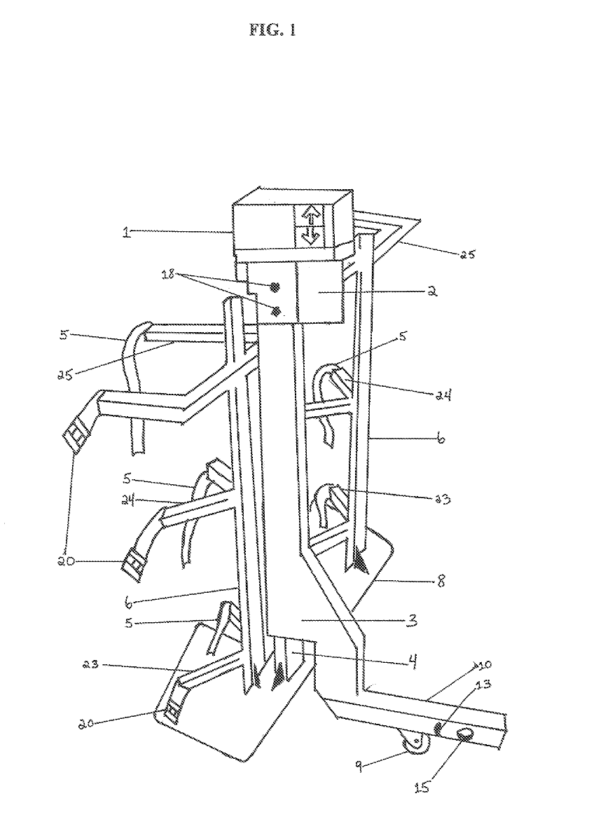

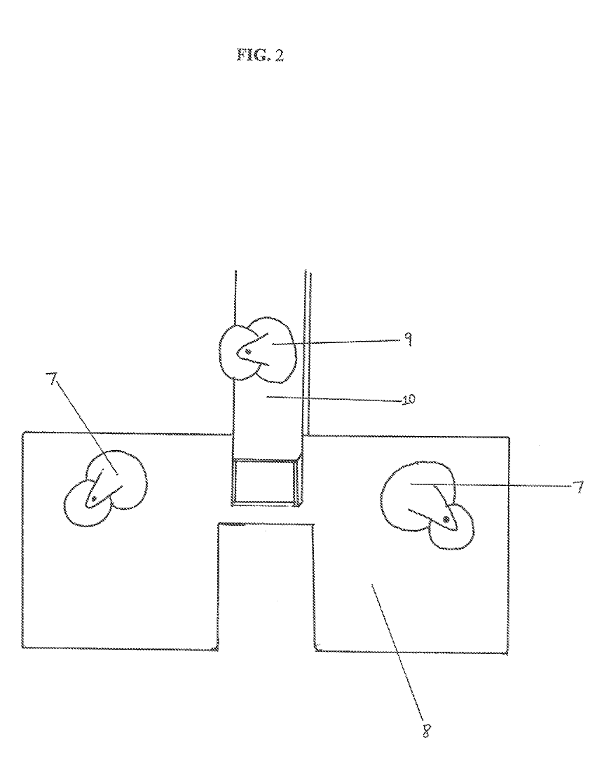

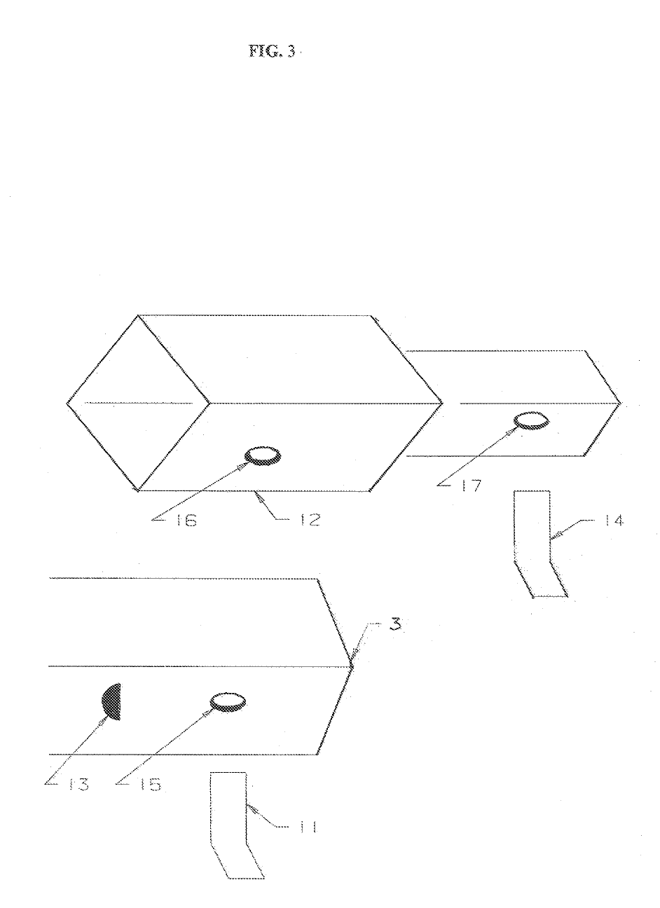

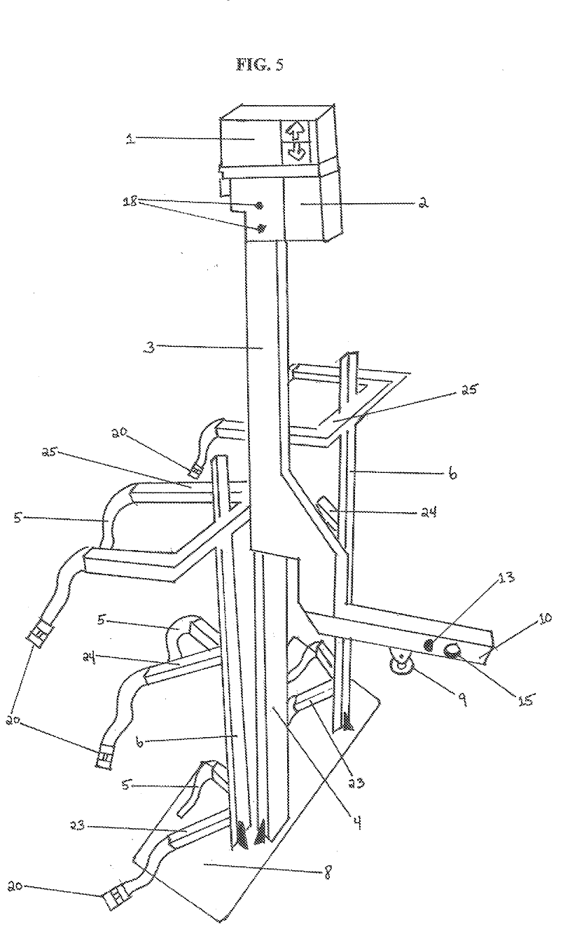

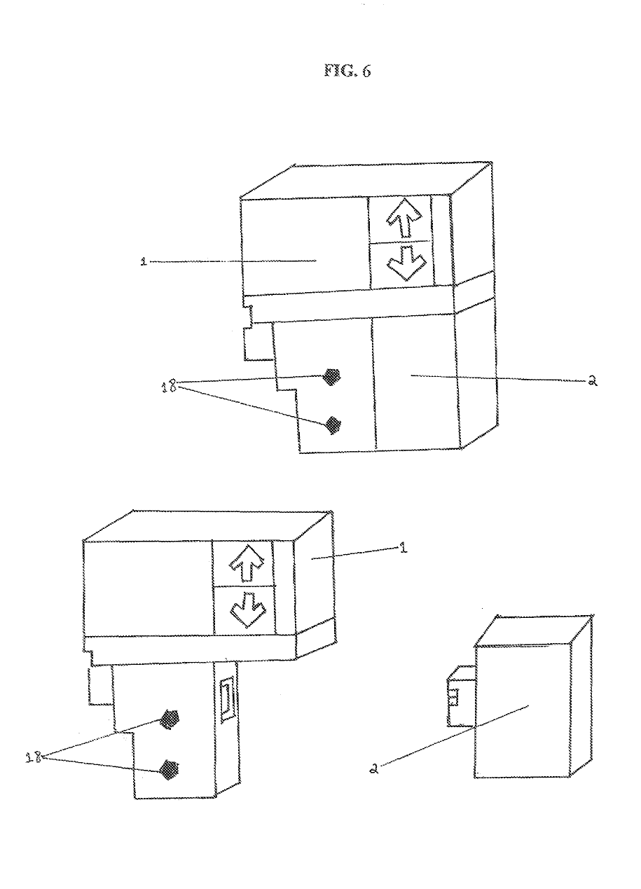

Referring to the drawings, wherein like reference numerals represent like parts throughout the various drawing figures. Description of the invention is as follows. A 12-volt D/C gear motor 1, is affixed to the top most portion of the tower outer tube 3, via the use of setscrews 18. The 12-volt D/C gear motor 1 has a rechargeable 12-volt D/C battery 2, which has the ability to be removed (FIG. 6). The 12 volt D/C gear motor 1 has attached to its rotating shaft a threaded shaft, both the 12 volt D/C gear motor 1 and the threaded shaft, are affixed to the tower outer tube 3. The tower outer tube 3 extends vertically providing support for the attachment point of the invention to the motor vehicle trailer hitch receiver. The tower outer tube 3 supplies a cavity, which houses the tower inner tube 4, this tower inner tube 4 projects out slightly from the bottom margin of the tower outer tube 3 (FIG. 1). The tower inner tube 4 has attached to its top margin a nut, through this nut the threaded shaft is positioned. The orientation of the 12-volt D/C gear motor 1, direction of rotation and the position of the threaded shaft, within the nut, is what allows the tower inner tube 4 to extend and retract in respect to the position of the tower outer tube 3 (FIG. 5). Once the invention has been dissociated from the motor vehicle tower inner tube 4 is placed in its retracted position within tower outer tube 3, via 12 volt D/C gear motor 1. The swivel caster wheels on platform 7 and swivel caster wheel on tongue 9 are horizontally aligned in respect to one another, allowing three points of contact with a support surface. The invention now can be transported from the motor vehicle to a storage facility. With the invention dissociated from the motor vehicle but positioned at the rearward of the motor vehicle the tower inner tube 4 is placed in an extended position via 12 volt D/C gear motor 1. Alignment of the tower outer tube 3 is achieved with the adapter sleeve 12, now allowing insertion of tower outer tube 3 within adapter sleeve 12 (FIG. 3). Pin 11 resists tower outer tube 3 from being removed from adapter sleeve 12, by passing through tower outer tube hole 15, and adapter sleeve hole 16. The tower inner tube 4 has attached to it at its base a platform 8. Platform 8 supports the golf bags and pull carts during transportation via motor vehicle, or during transportation from one location to another while on the ground. While the invention is on the ground ease of movement is allowed due to the placement of swivel caster wheels on platform 7 as well as swivel caster wheel on tongue 9 (FIG. 2). Projecting vertically from platform 8 are two removable supports 6. These removable supports 6 are fastened to platform 8 with retaining bolt. The removable supports 6 have along there vertical length a bottom cradle 23, a middle cradle 24 and a top cradle 25, which supply support to the golf bag and pull cart during loading and transportation. The bottom cradle 23, middle cradle 24 as well as the top cradle 25 are all permanently attached to the removable supports 6 and have an orientation of angulation rearward in respect to forward motion of the motor vehicle. Bottom cradle 23, middle cradle 24 as well as top cradle 25 have straps 5, and locking clips 20 which circumferentially restrain the golf bag and golf bag pull carts from becoming dislodged during transportation.

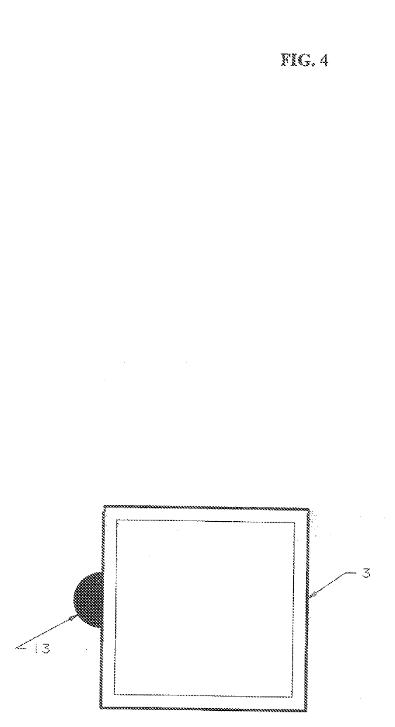

An adapter sleeve 12 is supplied to allow the invention to be used with either 1¼ or 2-inch vehicle hitch receivers. The adapter sleeve 12 has 2 holes. Hole 17 is located to receive pin 14, this pinning location will secure the adapter sleeve 12 to the vehicle hitch receiver. Hole 16 has an exact location along the horizontal length of adapter sleeve 12, which when tower outer tube 3 is inserted into adapter sleeve 12, the presence of tower outer tube tab 13 (FIG. 4). limits the insertion depth and precisely aligns tower outer tube hole 15 with adapter sleeve hole 16. This orientation of tower outer tube hole 15 with adapter sleeve hole 16 and allows pin 11 to be retain tower outer tube 3 within adapter sleeve 12 (FIG. 2).

What is claimed is:

1. A golf bag and golf bag pull cart transportation and storage device powered by a rechargeable 12 volt D/C Battery for use with motor vehicles, including:
a platform having a surface for support of golf equipment as well as upright supports to stabilize golf equipment during transportation and swivel caster wheels; and
a tower housing an inner tube and an outer tube as well as a self contained rechargeable 12 volt D/C battery and a gear motor; and
a tongue configured for attachment to a motor vehicle hitch receiver.

2. A golf bag and golf bag pull cart transportation and storage device powered by a rechargeable 12 volt D/C Battery for use with motor vehicles of claim 1 wherein; said platform has a surface horizontal orientation which supports unto cranial surface said golf equipment equally spaced along right and left sides by means of supporting a minimum of one said golf bag and one said golf bag pull cart.

3. A golf bag and golf bag pull cart transportation and storage device powered by a rechargeable 12 volt D/C Battery for use with motor vehicles of claim 1 wherein; said platform has a caudal surface affixed to said caudal surface are swivel caster wheels.

4. A golf bag and golf bag pull cart transportation and storage device powered by a rechargeable 12 volt D/C Battery for use with motor vehicles of claim 1 wherein; said platform has an anterior surface affixed to said platform anterior surface is the caudal section of said inner tube of said tower.

5. A golf bag and golf bag pull cart transportation and storage device powered by a rechargeable 12 volt D/C Battery for use with motor vehicles of claim 1 wherein; said tower assumes a vertical orientation including said inner tube and said outer tube; and said inner tube translates in a vertical direction within said outer tube.

6. A golf bag and golf bag pull cart transportation and storage device powered by a rechargeable 12 volt D/C Battery for use with motor vehicles of claim 1 wherein; said tower outer tube is affixed said gear motor; and said gear motor has a drive shaft mechanism affixed to said tower inner tube.

7. A golf bag and golf bag pull cart transportation and storage device powered by a rechargeable 12 volt D/C Battery for use with motor vehicles of claim 1 wherein; the said gear motor is powered by said rechargeable 12 volt D/C Battery

8. A golf bag and golf bag pull cart transportation and storage device powered by a rechargeable 12 volt D/C Battery for use with motor vehicles of claim 1 wherein; said tongue having a first and second opposite sides; where said first side attaches to a motor vehicle hitch receiver and is retained to said motor vehicle hitch receiver with a locking pin.

9. A golf bag and golf bag pull cart transportation and storage device powered by a rechargeable 12 volt D/C Battery for use with motor vehicles of claim 8 wherein; said tongue having a second side attachment to said tower outer tube

10. A golf bag and golf bag pull cart transportation and storage device powered by a rechargeable 12 volt D/C Battery for use with motor vehicles of claim 8 wherein; said tongue first side having a centering tab limiting depth of insertion into said motor vehicle hitch receiver aligning said locking pin.

11. A golf bag and golf bag pull cart transportation and storage device powered by a rechargeable 12 volt D/C Battery for use with motor vehicles of claim 1 wherein; said platform has along its anterior margin equally spaced said supports.

12. A golf bag and golf bag pull cart transportation and storage device powered by a rechargeable 12 volt D/C Battery for use with motor vehicles of claim 11 wherein; said supports project in a vertical direction from said platform in addition affixed to said supports are a middle cradle and a top cradle.

13. A golf bag and golf bag pull cart transportation and storage device powered by a rechargeable 12 volt D/C Battery for use with motor vehicles of claim 12 wherein; said middle cradle and said top cradle having a V type shape, as well as a parallel orientation to said platform.

14. A golf bag and golf bag pull cart transportation and storage device powered by a rechargeable 12 volt D/C Battery for use with motor vehicles of claim 12 wherein; said middle cradle positioned equidistant from said platform and said top cradle.

15. A golf bag and golf bag pull cart transportation and storage device powered by a rechargeable 12 volt D/C Battery for use with motor vehicles of claim 12 wherein; said middle cradle and said top cradle includes flexible strapping couplers.

16. A golf bag and golf bag pull cart transportation and storage device powered by a rechargeable 12 volt D/C Battery for use with motor vehicles of claim 1 wherein; said tongue having a inner aspect as well as an outer aspect, where said inner aspect having holes oriented in such a way as to align with said motor vehicle hitch receiver and accept a locking pin.

17. A golf bag and golf bag pull cart transportation and storage device powered by a rechargeable 12 volt D/C Battery for use with motor vehicles of claim 1 wherein; said platform has proportionately positioned said swivel caster wheels for the invention to remain vertically balanced without outside support, while freestanding with and or without said golf equipment onto the invention.
